(19) United States
(12) Patent Application Publication
(10) Pub. No.: US 2012/0075742 A1
(43) Pub. Date: Mar. 29, 2012

(54) MAGNETIC DISK DEVICE, ELECTRONIC APPARATUS AND, HEAD CONTROL METHOD

(75) Inventors: Shinji Takakura, Kanagawa-ken (JP); Shigen Yasunaka, Kanagawa-ken (JP); Yoshiyuki Ishihara, Kanagawa-ken (JP)

(73) Assignee: KABUSHIKI KAISHA TOSHIBA, Tokyo (JP)

(21) Appl. No.: 13/051,176

(22) Filed: Mar. 18, 2011

(30) Foreign Application Priority Data
Sep. 28, 2010 (JP) 2010-217486

(51) Int. Cl. G11B 21/02

(52) U.S. Cl. 360/75; G9B/21.003

(57) ABSTRACT

A magnetic disk device includes a head, a coil motor, a drive circuit, a voltage detector, a head position calculation unit, a velocity calculation unit, a counter electromotive voltage calculation unit, a coil resistance estimation unit, and a control unit. The head position calculation unit calculates a position of the head for each sampling cycle on the basis of servo information. The velocity calculation unit calculates a velocity of the head for each sampling cycle. The counter electromotive voltage calculation unit calculates a counter electromotive voltage of the coil for each sampling cycle. The coil resistance estimation unit successively estimates a coil resistance value of the coil. The control unit calculates a drive instruction for controlling the velocity and outputs the drive instruction to the drive circuit. In addition, the counter electromotive voltage calculation unit subtracts a voltage drop from the inter-terminal voltage to calculate the counter electromotive voltage.

### CROSS REFERENCE TO RELATED APPLICATION

This application is based upon and claims the benefit of priority from the prior Japanese Patent Application No. 2010-217486, filed on Sep. 28, 2010, the entire contents of which are incorporated herein by reference.

### FIELD

An embodiment relates basically to a magnetic disk device, an electronic apparatus, and a head control method.

### BACKGROUND

A head position error signal obtained by reproducing servo information included in servo sectors on a magnetic disk surface is used for positioning control and velocity control of a head of a magnetic disk device. However, it is impossible to obtain the head position error signal after the head enters a ramp mechanism, during an unload operation.

Therefore, during the unload operation, the velocity of the head is generally controlled on the basis of a head velocity which is estimated from a counter electromotive voltage generated in a voice coil motor so that the velocity control of the head can be performed even when the head is on the ramp mechanism. At this occasion, the counter electromotive voltage is calculated using a coil resistance value of a coil in the voice coil motor.

However, the coil resistance value may change with a temperature change caused by a current. Accordingly, during the unload operation, the coil resistance value may change, and the calculation may be performed using the changed coil resistance value. Therefore, there is an issue that causes a change in the counter electromotive voltage to be used for the velocity control of the head and instability in the unload operation of the head.

### BRIEF DESCRIPTION OF THE DRAWINGS

Aspects of this disclosure will become apparent upon reading the following detailed description and upon reference to accompanying drawings. The description and the associated drawings are provided to illustrate embodiments of the invention and not limited to the scope of the invention.

FIG. 1 is a schematic view showing a configuration of a magnetic disk device according to an embodiment.

FIG. 2 is an equivalent circuit schematic showing a VCM model according to the embodiment.

FIG. 3 is a block diagram showing an internal configuration of an MPU of the magnetic disk device according to the embodiment.

FIG. 4 is a block diagram showing signal processing in the MPU of the magnetic disk device according to the embodiment.

FIG. 5 is a block diagram showing a coil resistance estimation unit according to the embodiment.

FIG. 6 is a graph showing a change in a coil resistance estimate value in a simulation of the magnetic disk device according to the embodiment.

FIG. 7 is a graph showing a change in an estimated velocity of a head in a simulation of the magnetic disk device according to the embodiment.

FIG. 8 is a view showing a configuration of an electronic apparatus according to the embodiment.

### DESCRIPTION

As will be described below, according to an embodiment, a magnetic disk device includes a head, a coil motor, a drive circuit, a voltage detector, a head position calculation unit, a velocity calculation unit, a counter electromotive voltage calculation unit, a coil resistance estimation unit, and a control unit. The head performs read and write of information over an information storage medium having servo information. The coil motor moves the head. The drive circuit drives the coil motor. The voltage detector detects an inter-terminal voltage of a coil included in the coil motor. The head position calculation unit calculates a position of the head for each sampling cycle on the basis of the servo information. The velocity calculation unit calculates a velocity of the head at the position for each sampling cycle. The counter electromotive voltage calculation unit calculates a counter electromotive voltage of the coil for each sampling cycle. The coil resistance estimation unit successively estimates a coil resistance value of the coil on the basis of the velocity and the counter electromotive voltage. The control unit calculates a drive instruction for controlling the velocity for each sampling cycle on the basis of the counter electromotive voltage and outputs the drive instruction to the drive circuit. In addition, the counter electromotive voltage calculation unit subtracts a voltage drop to be caused by the coil resistance estimate value to be estimated by the coil resistance estimation unit from the inter-terminal voltage to calculate the counter electromotive voltage.

An electronic apparatus according to the embodiment includes the magnetic disk device according to the embodiment.

According to the embodiment, a head control method for a magnetic disk device includes the following steps. The magnetic disk device includes a head, a coil motor, a drive circuit, and a voltage detector. The head performs read and write of information over an information storage medium having servo information. The coil motor moves the head. The drive circuit drives the coil motor. The voltage detector detects an inter-terminal voltage of a coil included in the coil motor. The steps of the head control method include calculating a position of the head for each sampling cycle on the basis of the servo information; calculating a velocity of the head at the position for each sampling cycle; subtracting a coil resistance value of the coil from the inter-terminal voltage to calculate a counter electromotive voltage of the coil for each sampling cycle; successively estimating the coil resistance value on the basis of the velocity and the counter electromotive voltage; and calculating a drive instruction to control the velocity for each sampling cycle on the basis of the counter electromotive voltage.

### EMBODIMENT

An embodiment will be explained below.

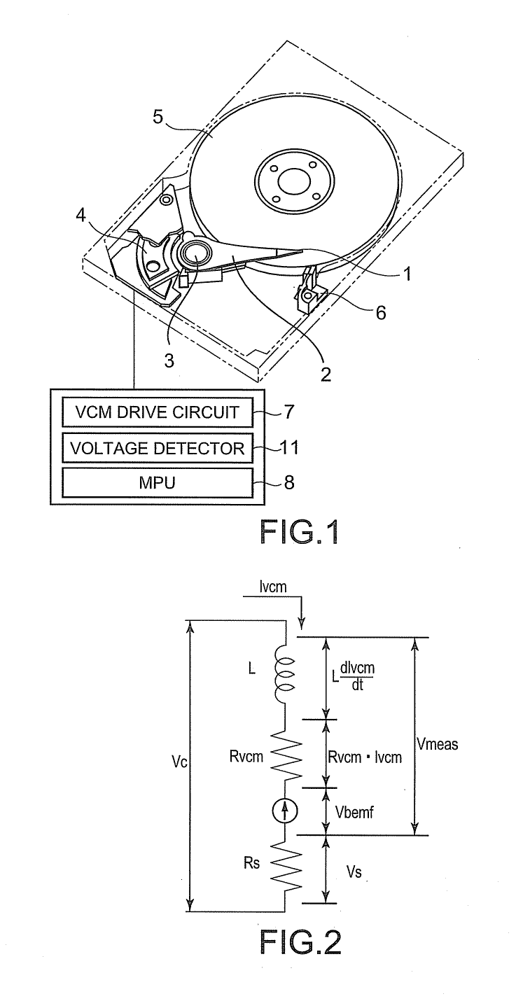

FIG. 1 is a schematic view showing a configuration of a magnetic disk device according to an embodiment. FIG. 2 is an equivalent circuit schematic showing a voice coil motor (VCM) 4 of the magnetic disk device according to the embodiment.

The schematic configuration of the magnetic disk device according to the embodiment will be explained with reference to FIG. 1.

In the embodiment, the magnetic disk device includes a head 1 to perform read and write of information over an information storage medium 5 such as a magnetic disk having a plurality of servo sectors, a VCM 4 to move the head 1, a VCM drive circuit 7 to drive the VCM 4, a voltage detector 11 to detect a coil inter-terminal voltage (i.e., a voltage between two terminals of a coil) in the VCM 4, and an MPU 8 to perform positioning control and velocity control of the head 1 on the basis of servo information magnetically recorded previously in servo sectors of the information storage medium 5.

The head 1 is supported at an end of an arm 2. When the VCM 4 makes the arm 2 pivot about a rotation axis 3, the head 1 moves in a radius direction over a surface of the information storage medium 5 rotated by a spindle motor, not shown, thereby performing a seek operation and a “follow” operation. As a result, the head 1 can perform write and read of information at any given location on the information storage medium 5. In the normal seek and follow operations, MPU 8 uses a positional error signal obtained from the servo information to perform positioning control of the head 1.

For example, when a shock detection sensor, not shown, detects a shock applied to the device, or when a user turns off the device, MPU 8 switches the control system from the positioning control to the velocity control, thereby performing an unload operation in which the head 1 is retracted to a ramp mechanism 6 adjacent to the information storage medium 5. On the contrary, when a recovery from the unload state is instructed, or when a user turns on the device, MPU 8 performs the velocity control to move the head 1 from the ramp mechanism 6 to the information storage medium 5.

For example, VCM 4 is a coil motor having a magnet and a coil to face each other. The magnet is fixed to a base portion. The coil is provided on an axially-supported arm 2. When a current passes through the coil, VCM 4 serves as an actuator which applies a rotational force to the arm 2, i.e., drives the arm 2.

The model of VCM 4 can be represented using an equivalent circuit schematic as shown in FIG. 2. L, Rvcm, and Rs denote an inductance, a coil resistance, and a sense resistor, respectively. Vbemf, Ivcm, Vmeas, and Vc denote a counter electromotive voltage, a current passing through the coil (referred to as a coil current below), a detectable coil inter-terminal voltage, and a voltage between the coil and the sense resistor, respectively.

The VCM drive circuit 7 receives an instruction voltage (drive instruction) from MPU 8, and passes a current through the coil to drive the arm 2. The VCM drive circuit 7 may have a known configuration including a current feedback circuit. The VCM drive circuit 7 is provided separately from VCM 4. However, the VCM drive circuit 7 and VCM 4 are actually connected. Accordingly, the coil of VCM 4 may be included in a part of the VCM drive circuit 7.

The voltage detector 11 successively detects the coil inter-terminal voltage Vmeas. In the embodiment, the voltage detector 11 is separately provided. However, the voltage detector 11 may be provided as a part of the VCM drive circuit 7.

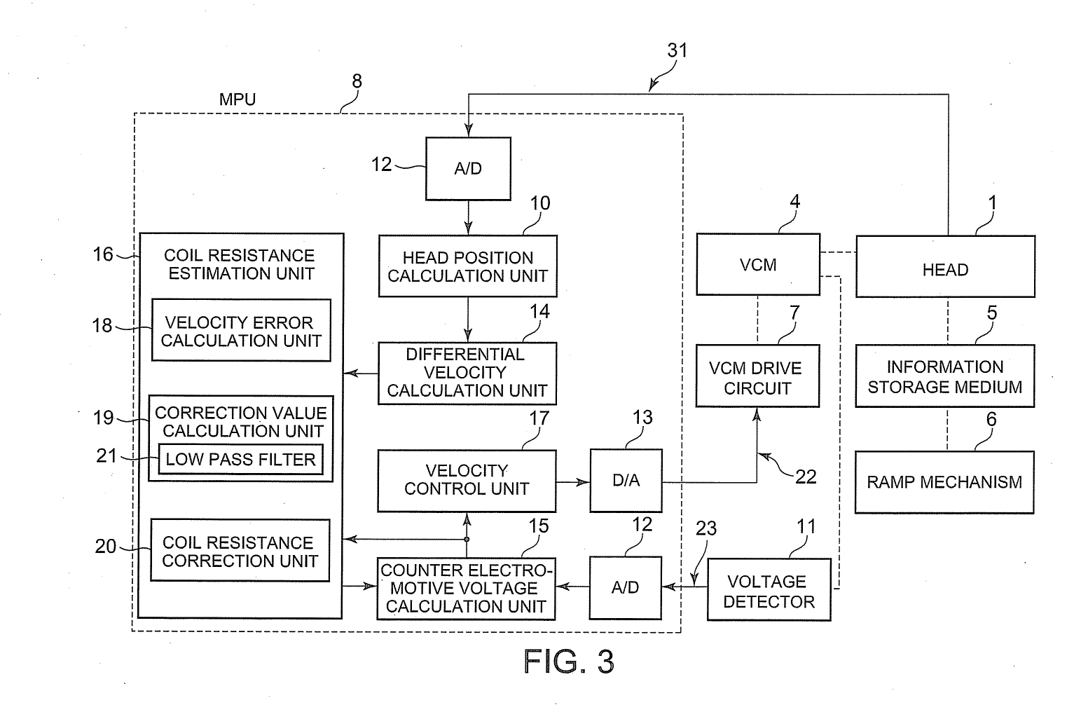

A configuration and an operation inside the MPU of the magnetic disk device according to the embodiment will be explained with reference to FIGS. 3 to 5. In the magnetic disk device according to the embodiment, known techniques are used for the seek operation and the follow operation. Operations to be performed during the unload operation will be explained below.

As described above, the counter electromotive voltage of the coil in VCM 4 is used in general for the velocity control of the head during the unload operation in which the head 1 is retracted to the ramp mechanism 6. A head velocity Vel is expressed by the following equation using a torque constant Kt and a coil counter electromotive voltage Vbemf.

Vel−V_{bemf}/Kₜ [Equation 1]

However, the coil resistance value varies with heat generated by a current passing through the coil during the unload operation and depending on lot differences. This variation also causes a variation in the counter electromotive voltage to be calculated on the basis of the coil resistance value.

The magnetic disk device according to the embodiment has the configuration as shown in FIG. 3. During the unload operation, the coil resistance value is successively estimated as long as the head position error signal can be obtained from the information storage medium 5 while the head 1 is located over the information storage medium 5. Thus, MPU 8 can calculate a more accurate counter electromotive voltage using the estimated coil resistance value, and can stably perform velocity control of the head 1.

After the head 1 leaves the information storage medium 5 to enter the ramp mechanism 6, the coil resistance value which has been estimated and obtained until just before the leaving of the head 1 allows it to perform the velocity control on the basis of the more accurate counter electromotive voltage

As shown in FIG. 3, MPU 8 includes a velocity calculation unit 14 to calculate the velocity of the head 1, a counter electromotive voltage calculation unit 15 to calculate the counter electromotive voltage of the coil, a coil resistance estimation unit 16 to successively estimate the coil resistance value, and a control unit 17 to calculate the instruction voltage used for the velocity control of the head 1 and to output the calculated instruction voltage to the VCM drive circuit 7.

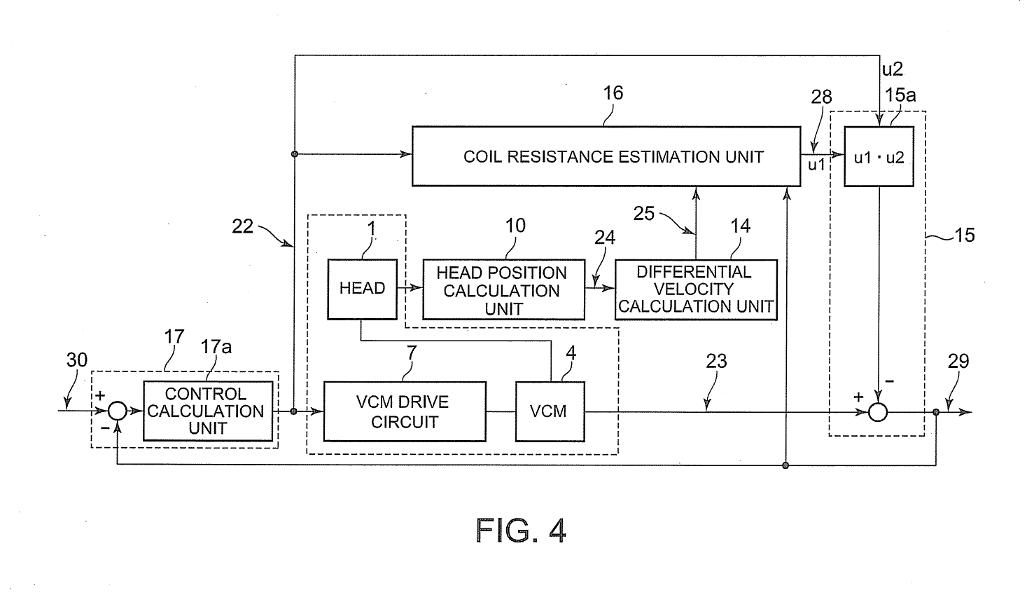

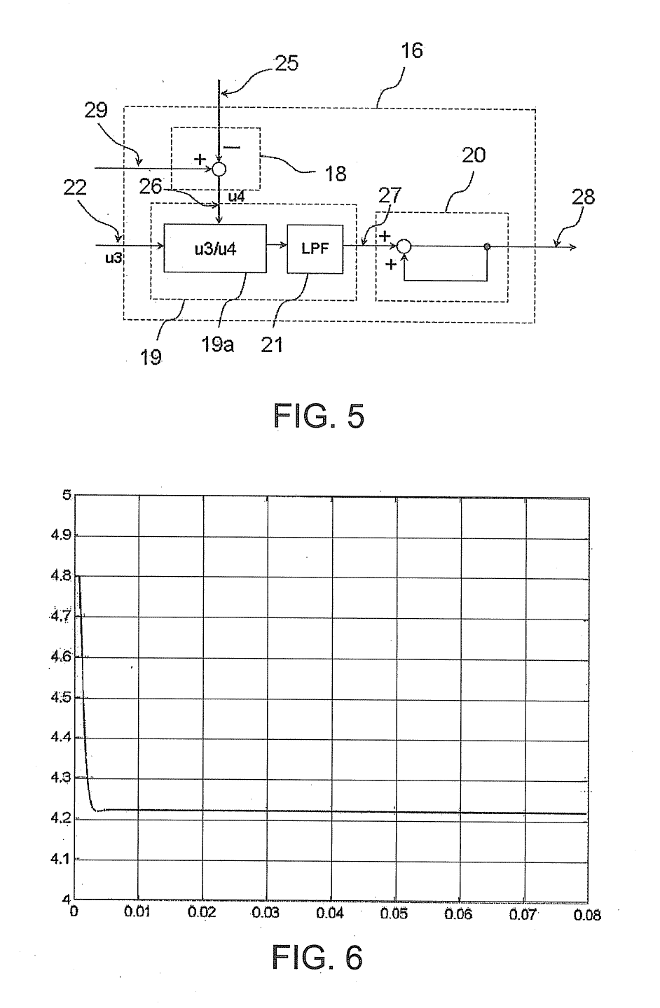

“Signal” processing inside the MPU during the velocity control of the head 1 will be explained in detail below with reference to FIGS. 4 and 5. The signal means data corresponding to a physical quantity.

FIG. 4 is a block diagram showing signal processing inside the MPU of the magnetic disk device according to the embodiment.

The head position calculation unit 10 receives the head position error signal, which the head 1 outputs by reproducing the servo information, via an AD converter 12 to subsequently calculate a head position signal on the basis of the head position error signal. At this occasion, the head 1 can reproduce the servo information for each servo sector. Therefore, the head position calculation unit 10 employs a cycle from a servo sector to the next servo sector as a sampling cycle to calculate the head position signal for each sampling action.

However, the head position signal thus calculated by the head position calculation unit 10 includes an eccentric component generated by the rotation of the information storage medium 5. It is necessary to remove the eccentric component. At this occasion, the eccentric component can be removed with a rotationally-synchronized component compensation used for an ordinary head positioning control.

The velocity calculation unit 14 calculates a velocity signal of the head 1 for each sampling cycle from a difference between a head position signal for a sampling cycle and another head position signal for the previous sampling cycle immediately preceding the sampling cycle (referred to as the “one cycle-preceding sampling cycle” below) both being calculated by the head position calculation unit 10. The velocity signal of the head 1 is a velocity serving as a reference to estimate the coil resistance. The velocity is calculated here on the basis of the difference. Alternatively, any method may be employed as long as the velocity can be calculated from the head position signal.

The counter electromotive voltage calculation unit 15 calculates the counter electromotive voltage of the coil for each sampling cycle from an estimated coil inter-terminal voltage and an estimated value of the coil resistance (referred to as a “coil resistance estimate value” below). The counter electromotive voltage Vbemf is expressed by the following equation when the sampling cycle takes a time interval sufficient for attenuating the voltage caused by inductance to remove effect of an inductance term.

V_{bemf}=Vₘₑₐₙₛ−R_{vcm}·I_{vcm} [Equation 2]

In the equation 2, Vmeas, Rvcm, and Ivcm denote a coil inter-terminal voltage, a coil resistance, and a coil current, respectively. When the current feedback sufficiently takes effect, the coil current Ivcm is proportional to the instruction voltage Vvcm, and the relationship therebetween can be expressed as Ivcm=βVvcm, in which β is a proportionality coefficient. Accordingly, the counter electromotive voltage Vbemf can be expressed by the following equation.

$$\begin{matrix}{V}_{δ emf} = {V}_{meas} - {R}_{vcm} \cdot β \cdot {V}_{vcm} \\ = {V}_{meas} - R \cdot {V}_{vcm}\end{matrix} \qquad [ Equation 3 ]$$

In the above equation, “the proportionality coefficient β× the coil resistance Rvcm” is replaced by R to be regarded as a coil resistance estimate value. In accordance with the equation 3, the counter electromotive voltage calculation unit 15 subtracts a multiplied value from the coil inter-terminal voltage to calculate a counter-electromotive voltage for each sampling cycle. The multiplied value is obtained by multiplying the coil resistance estimate value outputted from the coil resistance estimation unit 16 for each sampling cycle by the instruction voltage for the one cycle-preceding sampling cycle. The coil inter-terminal voltage is outputted by the voltage detector 11 and processed by the AD converter 12. This multiplication is performed by a multiplication unit 15a provided to the counter electromotive voltage calculation unit 15.

However, at the start of the unload operation, the coil resistance estimation unit 16 has not yet calculated the coil resistance estimate value, requiring a predetermined coil resistance value R0 as an initial value. The predetermined coil resistance value R0 may be obtained by calibration before starting the unload operation, or may be obtained using a nominal value of the coil resistance values previously stored in a storage unit such as a memory, not shown. At the start of the unload operation, the counter electromotive voltage calculation unit 15 uses the predetermined coil resistance value R0 to calculate a counter electromotive voltage.

The coil resistance estimation unit 16 includes a velocity error calculation unit 18, a correction value calculation unit 19, and a coil resistance correction unit 20. The coil resistance estimation unit 16 will be explained in detail below with reference to the block diagram of FIG. 5.

First, the velocity error calculation unit 18 obtains a velocity signal Vel outputted from the velocity calculation unit 14 and the counter electromotive voltage Vbemf outputted from the counter electromotive voltage calculation unit 15 for each sampling cycle. Then, as shown in the following equation, the velocity signal Vel is subtracted from the counter electromotive voltage Vbemf to calculate a velocity error signal ΔVel for each sampling cycle.

ΔVel=V_{bemf}−Vel [Equation 4]

As described above, the velocity signal Vel is used as the reference velocity to estimate the coil resistance. In other words, when the head velocity is regarded as a true value, the velocity signal Vel can be virtually expressed by the following equation using a value Rreal (referred to as a reference coil resistance value below) to be obtained by multiplying the true value of the coil resistance by the proportionality coefficient β.

Vel=Vₘₑₐₙₛ−Rᵣₑₐₗ·V_{vcm} [Equation 5]

On the other hand, the coil resistance estimate value R is expressed as R=Rreal+ΔR using the coil resistance error ΔR, thereby allowing it to transform the equation 3 into the following equation.

V_{bemf}=Vₘₑₐₙₛ−(Rᵣₑₐₗ+ΔR)·V_{vcm} [Equation 6]

As can be understood from the equations 4 to 6, the velocity error signal ΔVel includes only the error ΔR with respect to the reference coil resistance value.

In the correction value calculation unit 19, a division unit 19a calculates a correction value α of a successive coil resistance for each sampling cycle by dividing the velocity error signal ΔVel by the instruction voltage for the one-cycle preceding sampling cycle as shown in the following equation.

ΔVel/V_{vcm}=(V_{bemf}−Vel)/V_{vcm}=−ΔR≡α [Equation 7]

As can be seen in the above equation, the positive and negative errors ΔR of the coil resistance make the correction value α negative and positive, respectively. When the correction value α is zero, the coil resistance estimate value R is substantially equal to the reference coil resistance value Rreal. Therefore, even when the real value of the coil resistance changes, the coil resistance can be successively estimated by making the correction value α converge with zero.

The correction value calculation unit 19 also has a low pass filter 21. Filtering the output of the correction value α with the low pass filter 21 allows it to control a convergence velocity of the correction value α in accordance with a cutoff frequency. If the cut off frequency is too high, the correction value α converges in a vibrating manner. If the cut off frequency is too low, the correction value α converges too slowly. Accordingly, the cut off frequency can be previously adjusted in accordance with the purpose of the magnetic disk device and its desired performance.

As shown in the following equation, the coil resistance correction unit 20 calculates the coil resistance estimate value for each sampling cycle by adding the coil resistance correction value α outputted from the correction value calculation unit 19 to the coil resistance estimate value R for the one cycle-preceding sampling cycle.

Rₖ=Rₖ₋₁+αₖ [Equation 8]

In the above equation, a variable k is a natural number of 1 or more, and represents a sampling number of each sampling cycle. Therefore, at the start of the unload operation, the coil resistance correction unit 20 calculates the first coil resistance estimate value by adding the first coil resistance correction value to the predetermined coil resistance R0. Thereafter, the coil resistance correction unit 20 successively calculates the coil resistance estimate value for each sampling cycle in accordance with the equation 8.

For each sampling cycle, the control unit 17 receives a feedback signal of a counter electromotive voltage outputted from the counter electromotive voltage calculation unit 15 and a target velocity signal previously stored in a memory or the like to calculate a difference between the counter electromotive voltage and the target velocity signal. A control calculation unit 17a performs calculation such as PI control for the difference to calculate the instruction voltage for each sampling cycle.

Alternatively, the target velocity signal may be given as a constant value, or may be given as a function of the time and distance to reach a target value, for example. The target velocity signal is assumed to be previously stored in a memory or the like. Alternatively, the target velocity signal may be successively calculated by MPU 8 during the unload operation.

At the start of the unload operation, the predetermined coil resistance R0 used for estimating the coil resistance may have previously shifted from the true value. Accordingly, at the start of the unload operation, the PI gain may be set to a small value and may be increased up to a predetermined value immediately after the correction value decreases down to a predetermined value or less.

The description is based on the PI control. Alternatively, PID control, PD control, and other control regulations may be employed.

The instruction voltage thus calculated by the control unit 17 is outputted to the VCM drive circuit 7 via a DA converter 13. The VCM drive circuit 7 actually controls a coil current to enable the unload operation of the head 1 which is velocity-controlled.

The time to start the above unload operation may be based on timing for the control of the head 1 to change from the positioning control to the velocity control, i.e., timing to start the velocity control by using the instruction voltage to be calculated by the control unit 17.

In the description of the embodiment, the coil resistance is estimated during the unload operation. However, even during the load operation or before starting the unload operation, the coil resistance can be successively estimated while the head position error signal could be obtained from the information storage medium 5.

In the embodiment, the virtual quantity including the coil current Ivcm and the proportionality coefficient β of the instruction voltage Vvcm is employed as the coil resistance estimate value. Alternatively, when the value β is previously known, the real physical quantity excluding the effect of β may be employed as the coil resistance estimate value.

In the above description, the head 1 is located above the information storage medium 5 during the unload operation. In other words, the servo information is obtained from the information storage medium 5 during the unload operation. Alternatively, when the head 1 enters the ramp mechanism 6 to obtain no servo information, the velocity control of the head 1 can be performed using a counter electromotive voltage. The counter electromotive voltage is calculated by the counter electromotive voltage calculation unit 15 on the basis of the coil resistance value which is estimated by the coil resistance estimation unit 28 immediately before the head 1 leaves the information recording medium 5.

Now, a simulation is performed as an example using the embodiment. In the simulation, the initial value of the coil resistance is different from the true value thereof.

FIG. 6 is a graph showing a change in the coil resistance estimate value. As can be seen, an error is involved at the start of the unload operation, but the coil resistance estimate value converges with a constant value, i.e., a true value, as time passes.

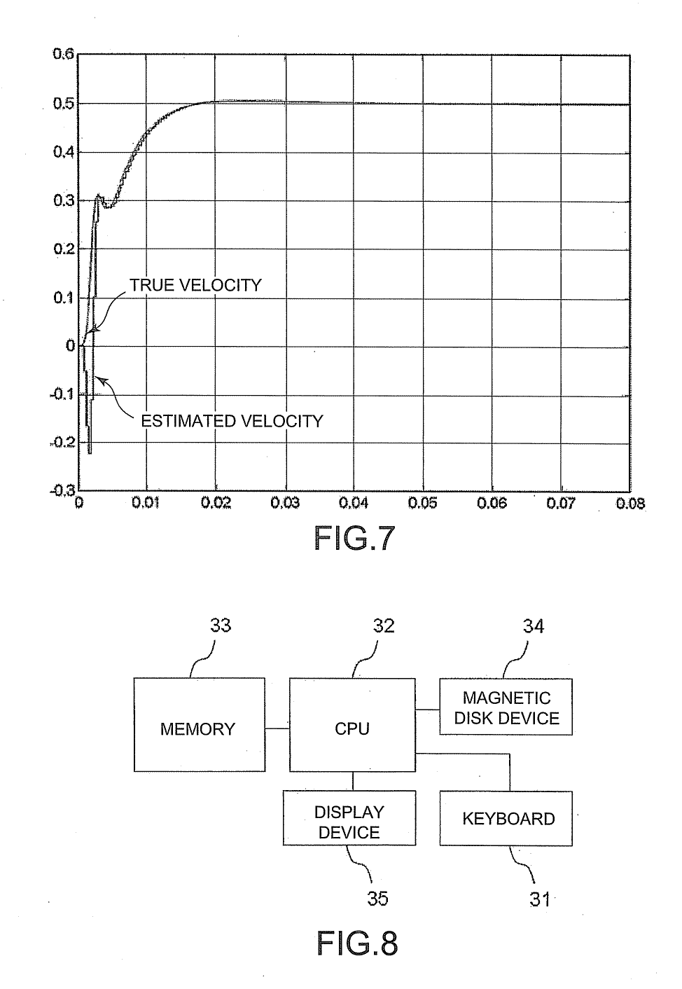

FIG. 7 is a graph showing a change in the estimated velocity of the head 1 to be calculated on the basis of the coil resistance estimate value. As can be seen, the coil resistance estimate value involves an error at the start of the unload operation. The estimated velocity calculated on the basis of the value thereof is greatly different from the true velocity calculated from a head position. However, as the coil resistance estimate value converges with the true value, the estimated velocity clearly converges with the true velocity.

The magnetic disk device according to the embodiment enables the unload operation of the head 1 to be stably performed by successively estimating the coil resistance even when the coil resistance in the coil motor changes during the unload operation of the head 1.

The magnetic disk device according to the embodiment can be mounted on various kinds of electronic devices and the like. FIG. 8 is a view showing a configuration of an electronic apparatus as an application example of the embodiment. The application example of the electronic apparatus is explained using a computer. The computer includes a keyboard 31, a CPU 32, a memory 33, a magnetic disk 34 device according to the embodiment, and a display device 35.

The keyboard 31 is an input device which a user uses to input commands and characters to the computer. The CPU 32 performs various kinds of processing and operations such as calculations on the basis of the information which the user inputs using the keyboard 31. The memory 33 temporarily stores data and stores control programs for the processing and operations performed by the CPU 32. The CPU 32 performs write/read of data on/from the magnetic disk device 34. The display device 35 displays information or the like inputted by the user.

This computer enables the magnetic disk device according to the embodiment to operate in a stable manner, thereby enhancing the reliability of data storage or shortening a storing time thereof.

In the description of the embodiment, the computer is used as an example. Alternatively, the embodiment can be applied to every electronic apparatus which may include the magnetic disk device, such as a television set and a camcorder.

While a certain embodiment of the invention has been described, the embodiment has been presented by way of examples only, and is not intended to limit the scope of the inventions. Indeed, the novel elements and apparatuses described herein may be embodied in a variety of other forms; furthermore, various omissions, substitutions and changes in the form of the methods described herein may be made without departing from the spirit of the invention. The accompanying claims and their equivalents are intended to cover such forms or modifications as would fall within the scope and spirit of the invention.

What is claimed is:

1. A magnetic disk device comprising:
a head to perform read and write of information over an information storage medium having servo information;
a coil motor to move the head;
a drive circuit to drive the coil motor;
a voltage detector to detect an inter-terminal voltage of a coil included in the coil motor;
a head position calculation unit to calculate a position of the head for each sampling cycle on the basis of the servo information;
a velocity calculation unit to calculate a velocity of the head at the position for each sampling cycle;
a counter electromotive voltage calculation unit to calculate a counter electromotive voltage of the coil for each sampling cycle;
a coil resistance estimation unit to successively estimate a coil resistance value of the coil on the basis of the velocity and the counter electromotive voltage; and
a control unit to calculate a drive instruction for controlling the velocity for each sampling cycle on the basis of the counter electromotive voltage and to output the drive instruction to the drive circuit,
wherein
the counter electromotive voltage calculation unit subtracts a voltage drop to be caused by the coil resistance estimate value to be estimated by the coil resistance estimation unit from the inter-terminal voltage to calculate the counter electromotive voltage.

2. The device according to claim 1, wherein
the coil resistance estimation unit further includes:
a velocity error calculation unit for subtracting the velocity from the counter electromotive voltage to calculate a head velocity error;
a correction value calculation unit for dividing the head velocity error by the drive instruction to successively calculate a correction value of the coil resistance value; and
a coil resistance correction unit which multiplies the correction value by the predetermined coil resistance value by using a predetermined coil resistance value as an initial value to successively calculate the coil resistance estimate value.

3. The device according to claim 2,
wherein
the coil resistance correction unit sets a sample number k for each sampling cycle to a natural number of 1 or more to calculate a first estimate value by using the following equation (1) when k is 1,
R₁×R₀+α₁ Equation (1)
(R₁ denoting the first coil resistance estimate value, R₀ denoting a predetermined coil resistance value, a denoting a first correction value); and
wherein
the coil resistance correction unit successively calculates a k^{th} estimate value by using the following equation (2) when k is more than 1,
Rₖ=Rₖ₋₁+αₖ Equation (2)
(Rₖ denoting the k^{th} coil resistance estimate value, Rₖ₋₁ denoting a (k−1)^{th} coil resistance estimate value, αₖ denoting a k^{th} correction value.)

4. The device according to claim 2, wherein
the correction value calculation unit further includes a filter, wherein a signal obtained by dividing the head velocity error signal by the drive instruction is subjected to filter processing by the filter, whereby the correction value is calculated.

5. The magnetic disk device according to claim 1, wherein
the coil resistance estimation unit successively estimates the coil resistance after the velocity control of the head starts in accordance with the drive instruction calculated by the control unit.

6. The device according to claim 1, wherein
when the head has not yet obtained the servo information, the counter electromotive voltage calculation unit subtracts a voltage drop from the inter-terminal voltage, the voltage drop being caused by the coil resistance estimate value to be estimated finally by the coil resistance estimation unit.

7. An electronic apparatus comprising the magnetic disk device according to claim 1.

8. A head control method for a magnetic disk device, comprising:
calculating a position of a head for each sampling cycle on the basis of servo information of an information storage medium;
calculating a velocity of the head at the position for each sampling cycle;
subtracting a coil resistance value of a coil from an inter-terminal voltage to calculate a counter electromotive voltage of the coil for each sampling cycle;
successively estimating the coil resistance value on the basis of the velocity and the counter electromotive voltage; and
calculating a drive instruction to control the velocity for each sampling cycle on the basis of the counter electromotive voltage,
wherein
the magnetic disk device includes:
the head to perform read and write of information over the information storage medium having the servo information;
a coil motor including the coil to move the head;
a drive circuit to drive the coil motor; and
a voltage detector to detect the inter-terminal voltage of the coil.
